(19) United States
(12) Patent Application Publication
(10) Pub. No.: US 2016/0041270 A1
(43) Pub. Date: Feb. 11, 2016

(54) SYSTEM AND METHOD FOR REAL-TIME THREE DIMENSIONAL DOSIMETRY

(71) Applicant: ATOMIC ENERGY OF CANADA LIMITED / ENERGIE ATOMIQUE DU CANADA LIMITEE, Chalk River (CA)

(72) Inventors: Xlongxin Dai, Deep River (CA); Junaid Qureshi, Brampton (CA); Guy Jonkmans, Deep River (CA)

(73) Assignee: ATOMIC ENERGY OF CANADA LIMITED / ENERGIE ATOMIQUE DU CANADA LIMITEE, Chalk River, ON (CA)

(21) Appl. No.: 14/780,238

(22) PCT Filed: Mar. 19, 2014
(86) PCT No.: PCT/CA2014/050293

§ 371 Date: Sep. 25, 2015

Related U.S. Application Data
(60) Provisional application No. 61/806,104, filed on Mar. 28, 2013.

(51) Int. Cl. G01T 1/02

(52) U.S. Cl. CPC G01T 1/023

(57) ABSTRACT

A system for determining a radiation dose in real time can include at least one three-dimensional target object to be exposed to ionizing radiation. The at least one target object may include a scintillating gel material. The scintillating gel material may emit light when exposed to the ionizing radiation. An imaging system may be configured to capture at least a first image of the target object from a first position, and a second image of the target object from a second position relative to the target object. A controller may be connected to the imaging system and may be configured to the process the first and second images to provide a three-dimensional dose distribution in real-time.

### CROSS-REFERENCE TO RELATED APPLICATIONS

This application claims the benefit of co-pending U.S. Provisional Patent Appn. No. 61/806,104, filed Mar. 28, 2013, the entirety of which is incorporated herein by reference.

### FIELD

The present subject matter of the teachings described herein relates generally to a system for real-time, three-dimensional dosimetry.

### BACKGROUND

3D dosimetry can be used in medical procedures to determine the radiation dose distribution in the human body that can be expected due to different medical procedure and techniques such as radiation therapy.

One current technique used to make these measurements requires a polymer gel dosimeter that can be irradiated. Polymer gel dosimeters may be fabricated from radiation sensitive chemicals which, upon irradiation, polymerize as a function of the absorbed radiation dose. After the irradiation is complete, the chemical changes are viewed by using techniques such as MRI, optical CT, or x-ray CT. This current method can be expensive and time consuming. Another drawback of the polymer gel method is that it does not provide real-time data. This means that measurements acquired are not taken as the gel is being irradiated but instead they are taken some time after the irradiation process. Further, the polymer gel dosimeter (or a phantom made therefrom) is not reusable as it has been polymerized by the radiation.

International Patent Application WO 2011/005862 (Mohan et al.) discloses a liquid scintillator detector for three-dimensional dosimetric measurement of a radiation beam. A volumetric phantom liquid scintillator is exposed to the radiation beam to produce light that is captured by cameras that provide a three-dimensional image of the beam.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In accordance with one broad aspect of the teachings described herein, which may be used in combination with any other aspects described herein, a system for determining a radiation dose in real time can include at least one three-dimensional target object to be exposed to ionizing radiation. The at least one target object may include a scintillating gel material. The scintillating gel material may emit light when exposed to the ionizing radiation. An imaging system may be configured to capture at least a first image of the target object from a first position, and a second image of the target object from a second position relative to the target object. A controller may be connected to the imaging system and may be configured to the process the first and second images to provide a three-dimensional dose distribution in real-time.

The scintillating gel material may be tissue equivalent and may contain about 10% Hydrogen (and may include about 10.2% H), about 67% Carbon (and may include about 67.4% C) and about 22% Oxygen (and may include about 22.4% O) (all expressed in weight percent), with a density of about 1 g/cm3. This composition may be considered as a tissue equivalent material for radiation dosimetry. The fluors used in the gel may include about 3.5 g/L of PPO and about 50 mg/L of bis-MSB.

At least a portion of the target objection may include a mold surrounding the scintillating gel.

Optionally, only a portion of the scintillating gel may be contained within a mold.

A support may at least partially support the scintillating gel material. Optionally, the support may simulate human bone and/or may include at least one human bone

The at least one target object may be formed from the scintillating gel and may substantially maintain its three-dimensional shape absent the presence of a mold.

The target object may be reusable and may not be chemically or physically altered by the ionizing radiation.

The imaging system may include at least one imaging device. The at least one imaging device may include at least one CCD digital camera.

The at least one imaging device may be moveable relative to the target object between the first and second positions.

The at least one imaging device may include a first imaging device in the first position and a second imaging device in the second position. At least one of the first and second imaging devices may be movable to a third position relative to the target object to capture a third image of the light emitted from the scintillating gel material.

The density of the scintillating gel may vary within the target object, and the target object may include at least one densified region that is configured to simulate human organ tissue, optionally including bone.

The densified region may provide a support for the scintillating gel, and optionally may simulate human bone.

At least one simulator object may be embedded within the scintillating gel.

A source of ionizing radiation may be embedded within the scintillating gel.

The target object may be of integral, one-piece construction, and may be formed entirely from the scintillating gel material.

In accordance with another broad aspect of the teachings described herein, which may be used in combination with any other aspects described herein, a method of determining a radiation dose in real time may include the steps of:

a) providing a target object formed from a scintillating gel material;

b) irradiating the target object with a source of ionizing radiation and producing light with the scintillating gel in response;

c) capturing a first image of the light produced by the scintillating gel from a first position relative to the target object;

d) capturing a second image of the light produced by the scintillating gel from a second position relative to the target object, the second position being spaced apart from the first position; and

e) generating a three-dimensional dose distribution of the target object based on at least the first and second images.

The three-dimensional dose distribution may be generated in real-time.

The first image may be captured using a first imaging device disposed in the first position.

The second image may be captured using the first imaging device after moving the first imaging device from the first position to the second position. Alternatively, the second image may be captured using a second imaging device disposed in the second position.

The method may also include embedding a non-gel object within the gel target object.

The method may also include embedding the source of ionizing radiation within the gel target object.

In accordance with another broad aspect of the teachings described herein, which may be used in combination with any other aspects described herein, a method of manufacturing a three-dimensional phantom may include the steps of:

a) pouring a scintillating material in fluid state into a three-dimensional phantom mold;

b) setting the scintillating material into a gel state to provide a three-dimensional gel phantom; and

c) removing at least a portion of the phantom mold to expose at least a portion of the three-dimensional gel phantom.

The method may also include removing substantially all of the phantom mold to provide a generally free-standing gel phantom.

The method may also include embedding a source of ionizing radiation within the phantom.

The method may also include providing a support within the scintillating gel, for supporting the gel when at least a portion of the mold is removed, and may optionally include providing at least one human bone as a support.

### DRAWINGS

The drawings included herewith are for illustrating various examples of articles, methods, and apparatuses of the teaching of the present specification and are not intended to limit the scope of what is taught in any way.

In the drawings:

FIG. 1 is a schematic representation of one embodiment of a dosimetry system;

FIG. 2 is a schematic representation of another embodiment of a dosimetry system;

FIG. 3 is a schematic representation of another embodiment of a dosimetry system;

FIG. 4 is a schematic representation of a mold for forming a gel phantom;

FIG. 5 is another perspective view of the mold of FIG. 4;

FIG. 6 is a view of the mold of FIG. 5 in an open configuration;

FIG. 7 is a schematic representation of a phantom formed using the mold of FIG. 4;

FIG. 8 is a schematic representation of another embodiment of a phantom;

FIG. 9 is a schematic representation of another embodiment of a phantom;

FIG. 10 is a schematic representation of another embodiment of a phantom;

FIG. 11 is an image of an irradiated a gel scintillator;

FIG. 12 is an image of an irradiated liquid scintillator;

FIG. 13 is an image of an irradiated blank gel material;

FIG. 14 is an image of irradiate water; and

FIG. 15 is a plot of subtracted background grayscale values of a gel scintillator versus the dose rate.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

A real-time, three-dimensional dosimetry system can be created by irradiating a target object or phantom that is at least partially formed form a scintillator material and then recording the optical photons produced using at least one suitable imaging apparatus. Measurements of the light output by the phantom can then be used to determine the amount of incoming or incident radiation that the phantom was exposed to and/or the dose distribution within the volume of the phantom.

In contrast to known dosimetry techniques that use a polymer gel dosimeters and/or liquid scintillating materials, the inventors have discovered that a real-time, three-dimensional dosimetry system may be designed including phantoms formed from a scintillating gel material.

Providing a scintillating gel material may be preferable over known polymer gel dosimeters for a variety of reasons, including, for example that the scintillating gel provides dosage information in real-time (in the form of emitted light) and the scintillating gel is reusable.

Providing a scintillating gel material may be also preferable over known liquid scintillating materials a variety of reasons, including, for example the scintillating gel may be tissue equivalent and may have a comparable efficiency relative to a liquid scintillator. Phantoms with a complex geometry may be created using a scintillating gel because since the gel material can be poured into the phantom mold while liquid and solidified to form any shape. Once the scintillating gel is solidified it may be able to generally retain its shape and is more viscous and less mobile than liquid scintillator material. This may allow a phantom formed from the scintillating gel material to be at least somewhat self-supporting such that it may retain its desired shape/configuration within a vessel, including in instances in which the vessel is not completely filled with the gel material. This may allow a given vessel to be used for different dosage readings/simulations depending on the particular arrangement of the gel material within the vessel. Alternatively, the gel material may need only partial support, resulting in any vessel or support element being less intrusive and having less effect on ionizing radiation and light emitted by the gel. Facilitating the re-use of a vessel may help reduce the amount of irradiated waste or other objects that must be handled when the dose measurements are complete.

Optionally, the scintillating gel can be used to hold objects in place (i.e. embedded or suspended within the gel material) without the need for additional supports or mounting members. In contrast, objects placed within a liquid scintillating material may tend to sink to the bottom of the container holding the liquid, or float to the free surface of the liquid. This may help enable the a scintillating gel phantom to be used to detect the localized dose deposited by internal alpha or beta source (or any other radiation source) that can be implanted or embedded within the scintillating gel as an alternative to, or in addition to, being exposed to external radiation (e.g. from a radiotherapy machine). This may help enable a scintillating gel phantom to be used to measure the dosage received from an embedded or internal radiation source, such as might be used in some forms of radiation therapy. A scintillating gel phantom may also help improve the accuracy of some measurements since complex body structures (such as bones) can be mimicked.

Providing a scintillating gel may also help reduce the chances that the scintillating material will be disturbed and may limit the formation of air bubbles and other impurities within the phantom while it is being moved or manipulated.

Preferably, the scintillating gel can be manufactured so that it is a generally tissue equivalent material, in terms of radiation dose. A tissue equivalent material will produce the same dose and/or dose distribution in the material as would be created in the tissue being modeled. This means that a tissue equivalent material being irradiated will undergo the same type of interactions at the same relative frequencies as the modeled tissue. Human tissue is primarily composed of four main elements with a ratio of C₅H₄₀O₁₈N which corresponds to a hydrogen percent mass composition of 10%. Using a scintillating gel, may help facilitate the production of a generally tissue equivalent scintillator. The scintillator gel may also have a density that is close to, or equal to, the density of tissue being modeled. Providing a scintillating gel that is tissue equivalent may enable the gel phantom formed from such material to more closely approximate or model the dose distribution of radiation that would be absorbed by human tissue under similar radiation conditions.

One example of a scintillating gel that is suitable for use in a real-time, three-dimensional dosimetry system (such as the system described herein) is a scintillating gel developed by Atomic Energy of Canada Limited (AECL) at its Chalk River Laboratories, located in Chalk River Ontario, Canada. As explained in more detail herein, the inventors have discovered that the scintillating gel developed by AECL has suitable physical/mechanical properties to form a desirable volumetric or three-dimensional phantom, suitable scintillation properties (as described below) and is sufficiently transparent to allow the generated light to be captured by a suitable imaging device. For example, a gel that was used by the Inventors for experimental purposes contained about 10.2% H, about 67.4% C and about 22.4% O, and was formulated to have a density of about 1 g/cm3. This composition may be considered to be a generally tissue equivalent material for radiation dosimetry. In the tested gel material, the scintillating fluors used in the gel were about 3.5 g/L of PPO and about 50 mg/L of bis-MSB. Modifying the fluor concentrations may help alter the light output of the gel material. Optionally, the density of the gel in the phantom can vary throughout the phantom, such that the phantom includes some relatively dense regions and some relatively less-dense regions.

Optionally, the scintillating gel and the dosimetry system can be configured to meet RTAP (Resolution-Time-Accuracy-Precision) criteria which require the spatial resolution to be ≦1 mm³, the imaging process should take ≦1 hour, the results should be accurate within 3%, and the precision should be within ≦1%.

A scintillating gel phantom may be safer than liquid scintillating materials. For example, if a container holding irradiated liquid scintillator material is broken, irradiated liquid may spill and flow out of the container. A gel scintillating material may be less likely to spill or spread if its surrounding container or mold is damaged. Further, the gel material tested by the inventors contains a significant fraction of water, and therefore may be less flammable and/or combustible than conventional liquid scintillators. In the tested gel, water comprised about 25% by weight of the gel material.

Preferably, the scintillating gel material is sufficient optically transparent so that light generated within the material, and a phantom formed therefrom, can escape the material to be detected by the imaging apparatus.

Optionally, the composition and/or characteristics of the gel material itself can also be varied. For example, a phantom may be formed from a scintillating gel that includes specified regions having different physical and/or chemical properties (e.g. regions of differing or varying density, composition). Providing regions or portions of the phantom with differing properties may allow different types of tissues (such as different organs) to be mimicked. This may help increase the overall accuracy of the dosage measurements. The gel composition may also be modified to suit other radiation modalities such as neutrons.

Examples of suitable imaging apparatuses may include one or more CCD digital cameras, CMOS digital cameras, Cerenkov Viewing Device (CVD), Quantitative Cerenkov Viewing Device (QCVD) and any other suitable camera or imaging device that is capable of capturing light or photons and producing a corresponding image.

To help provide a three-dimensional image of the dose distribution of radiation within the phantom, the imaging apparatus may be configured to record images of the phantom from two or more different positions or angles relative to the phantom. The resulting images can then be used to create a 3D image with the help of a 3D image reconstruction algorithm. Any suitable algorithm or image manipulating software may be used, including, for example ImageJ™ and any other suitable software. This image process may be conducted in substantially real-time (e.g. as the images are captured, as opposed to requiring hours or days to analyze). In such configurations, a three-dimensional dose distribution or image of the dosage within the phantom may be at least partially completed while the radiation is still being applied to the phantom.

Optionally, two or more cameras can be positioned in respective positions around the phantom. For example, two cameras may be arranged generally orthogonal to each other relative to the phantom, and/or additional cameras can be provided in additional positions around the phantom. Providing multiple cameras spaced apart from each other around the phantom (either in a single plane or in multiple planes) may help ensure the cameras are in a fixed, desired location relative to the phantom. This configuration may also allow images from all of the observing positions (i.e. all positions with a camera) to be captured simultaneously, substantially simultaneously and/or in any pre-determined order.

Alternatively, as few as one camera may be used to capture multiple images of the phantom from multiple positions. In such a configuration, each camera may be moveable relative to the phantom, between two or more different observing positions. For example, a frame or other suitable support structure may be provided upon with one or more cameras can be movably mounted. In this configuration, at least one actuator may be provided to move the camera(s). The actuator may be any suitable mechanism, including, for example, an electric servo motor, a belt drive, a chain drive, a ball screw, a pneumatic actuator or other mechanism that can move the camera(s) relative to the phantom with a desired level of speed and precision. Providing a moveable camera may help reduce the number of cameras or other imaging devices required in the dosimetry system. Providing a moveable camera may also allow the camera to be placed in different positions when capturing images of different phantoms. For example, a camera may be moveable between two positions to capture images of a generally elongate arm-shaped phantom, and then movable to two different positions to capture images of a generally, spherical head-shaped phantom. This may allow the camera to be positioned in a preferred orientation for each type of phantom, optionally, without having to reconfigure the supporting frame or other portions of the dosimetry system.

If moveable cameras are provided, the cameras may have any suitable degree(s) of freedom, and may be movable or rotatable about one or more suitable axis and/or within one or more suitable planes.

In some embodiments, the amount of light generated by the scintillating phantom may be relatively small, and may be difficult to observe in brightly lit rooms. Optionally, to help improve the quality of the images captured, the gel phantom may be irradiated in a dark or low-light area, the imaging devices used may be optimized for low light conditions, the phantom may be optically isolated from surrounding light sources and/or filters may be used to screen out ambient light emissions.

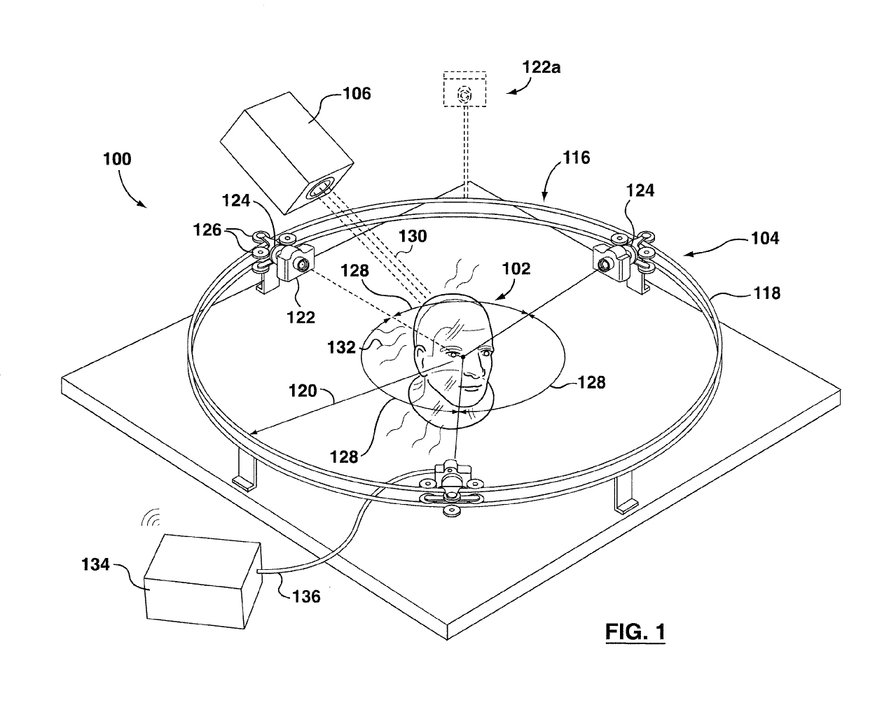

Referring to FIG. 1, one embodiment of a real-time, three-dimensional dosimetry system 100 includes a three-dimensional or volumetric target object or phantom 102 and an imaging apparatus 104. In the illustrated embodiment, the system 100 is positioned adjacent an apparatus 106 that is operable to emit ionizing radiation.

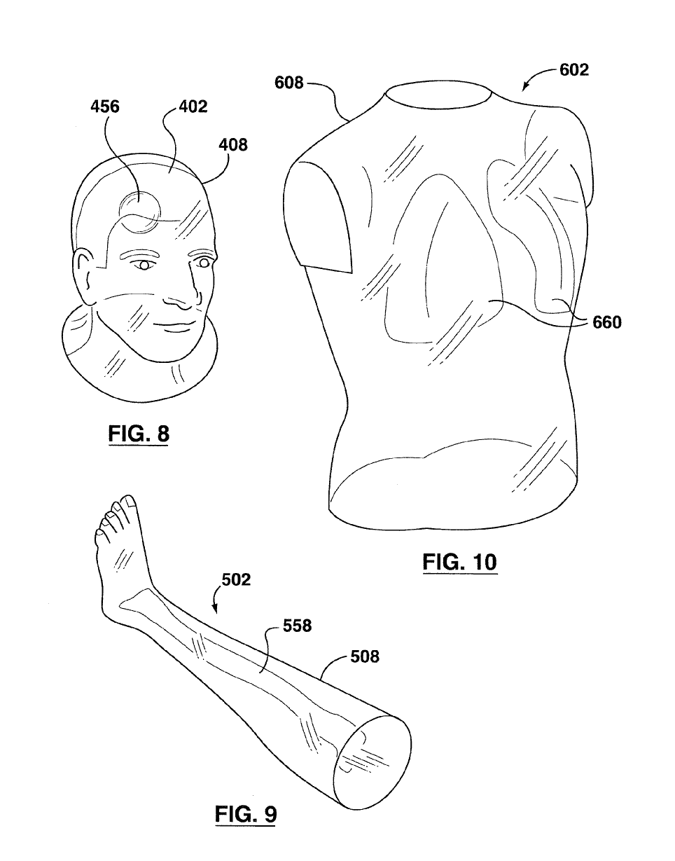

The apparatus 106 may be any suitable apparatus, including, for example a radiotherapy machine or other device that emits radiation. The ionizing radiation emitted by the apparatus 106, and measured using the system 100, may be any suitable type of radiation, including, for example particle beams or pencils, alpha radiation, beta radiation, proton or neutron beams, x-rays, gamma rays and any other types of radiation. Alternatively, instead of being used to measure the dosage of externally applied radiation (as shown in FIGS. 1-3), the dosimetry system 100 may also be used to measure the dosage of radiation sources that are located within the phantom 102 (see FIG. 8).

In the illustrated embodiment, the phantom 102 is provided in the form of a human head. To form a phantom 102 from the scintillating gel, a mold may be created in the form of the desired phantom. The mold may be a generic mold, or may be formed to accurately represent a given patient (for example by taking a cast of a portion of the patient's body, and/or by creating a 3D model of the patient's body portion).

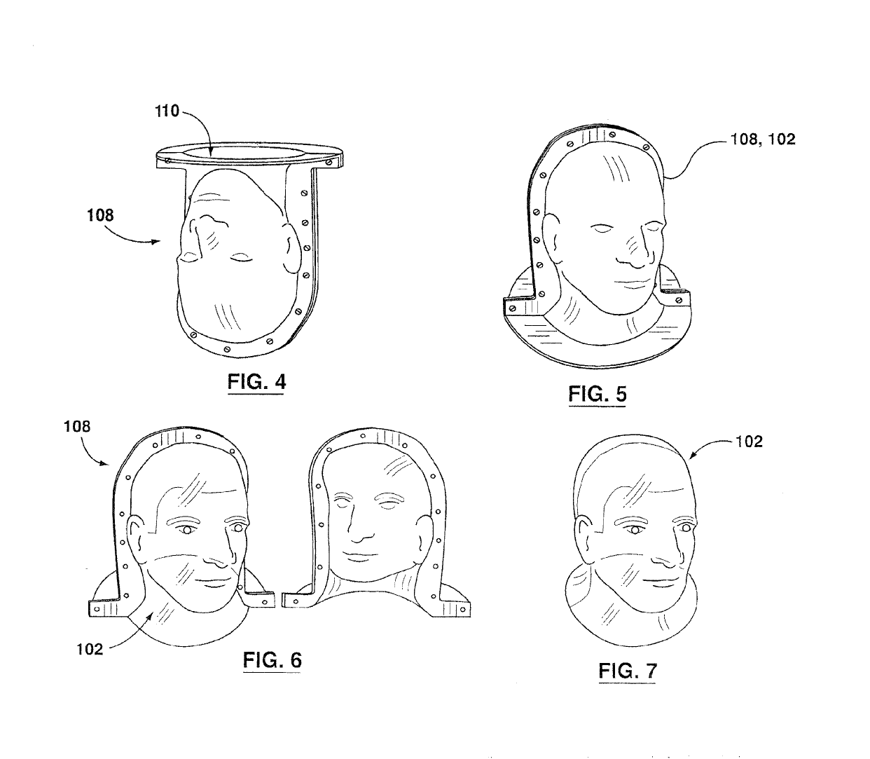

Referring to FIG. 4, the phantom 102 can be created by providing a generally head-shape mold 108. The mold 108 preferably includes at least one opening 110 into which scintillating material in its liquid state can be poured. When the mold 110 is filled, the scintillating material is allowed to cure or otherwise solidify into its gel state.

Optionally, the mold 108 may be formed from a material that can be irradiated without interfering with the accuracy of the dosimetry system 100 (FIG. 5). For example, the mold 108 made be made from an optically transparent material (for example the material used to contain liquid scintillating materials). In this configuration, for example when using the gel as tested by the inventors, some or all of the mold 108 may be left in place when the phantom 102 is subjected to the ionizing radiation. This may provide some additional structure and durability to the scintillating gel phantom 102. This may also protect the scintillating gel material during transport and/or storage of the phantom 102.

Alternatively, as illustrated in FIGS. 6 and 7, if the gel is formulated to be generally self-supporting the mold 108 may be separated from the scintillating gel material, once it has sufficiently solidified, to provide a phantom 102 that is formed the scintillating gel without an outer shell or container. In this configuration, the phantom 102 may be an integral, one-piece member that is formed entirely and/or exclusively from the scintillating gel material.

In one illustrated embodiment, the mold 108 includes mating mold portions 112a and 112b that can be joined together using fasteners 114 (or any other suitable mechanism) to provide an assembled mold 108, and then separated from each other (FIG. 6) to extract the phantom 102. Alternatively, the mold may more closely conform to the desired final shape of the phantom (i.e. not include substantial external flanges, etc.), as illustrated in FIGS. 8-10.

Optionally, as illustrated, the phantom 102 can be formed exclusively from the scintillating gel material. Alternatively, some portions of the phantom may be formed from other materials (such as plastics, etc.) to provide additional strength or other desired functionality.

While illustrated as being formed in the shape of a human body part, the target object or formed from the scintillating gel need not have a human-like shape. Instead, the phantom may be formed in any suitable shape, including, for example as a cylinder and/or a cube.

Referring again to FIG. 1, the dosimetry system 100 includes an imaging apparatus 104 that is positioned around the phantom 102. The imaging apparatus 104 may be any suitable apparatus and may include any number of imaging devices or cameras.

In the illustrated embodiment, the imaging apparatus 104 includes a frame 116 that is provided in the form a generally circular track 118 that surrounds the phantom 102. The track 118 may be of any suitable configuration, and may be formed from any suitable material, including, for example metal and plastic.

One or more imaging devices can be mounted on the track 118. Optionally, the imaging devices may be movably mounted on the track 118. If an imaging device is movably coupled to the track 118 it may be configured so that it can be moved into a given position and then locked in place to during the does measurement process, or it may be configured so that it can be moved between two or more positions while the does measurement process is underway. Alternatively, one or more of the imaging devices may be fixedly connected to the track 118.

In the illustrated embodiment, three imaging devices, in the form of CCD cameras 122 are mounted on the track 118. Each camera 122 in the illustrated example is movably mounted to the track 118 using a slider 124. The sliders 124 have a plurality of wheels 126 for rolling on the surfaces of the track 118.

Optionally, some or all of the sliders 124 may include a drive actuator (such as an electric motor) for powering at least some of the wheels 126 and moving the cameras 122 around the track 118. Providing a suitable drive actuator may allow the cameras 122 to be moved while dose measurement is underway, without requiring a human operator to be in close proximity to manually position the cameras 122. Alternatively, or in addition to provide a drive actuator on board the sliders 124, an external drive actuator may be provided to move some or all of the sliders 124. For example a belt or chain may be provided in the track 118 and driven by an external drive motor. The sliders 124 can be coupled to the belt of chain such that motion of the belt causes corresponding motion of the sliders 124 and cameras 122 thereon.

Alternatively, instead of providing an automated drive actuator, the sliders 124 may be manually movable by a human operator, who can roll them into their desired locations for a given measurement session. Optionally, the sliders 124 can include a locking mechanism (including for example a latch, clamp and pin) for securing the sliders 124 relative to the track 118. This may help prevent unwanted movement of the cameras 122 during the measurement process.

Optionally, the cameras 122 may be connected to the sliders 124 (or directly to the frame 116) in a fixed orientation (i.e. pointing generally toward the centre of the track 118). Alternatively, the cameras 112 may be movably, rotatably and/or pivotally connected to the sliders 124 (for example using a ball joint or pin joint) to provide an additional degree of freedom.

Optionally, the track 118 may be configured so that all of the sections of the track 118 are substantially the same distance 120 from the phantom 102. Providing a track 118 that is configured in this manner may enable any device or camera 122 mounted on the track 118 to be moved around to the phantom 102, without changing is spacing from the phantom 102. This may allow the cameras 122 to be re-positioned around the phantom 102 without needing to substantially adjust their focus length. This may help reduce the time required to reposition the camera 122 and capture an image of the phantom 102. It may also help reduce the changes of an image being captured out of focus.

If multiple cameras 122 are used, as illustrated in FIG. 1, they may be positioned around the phantom 102 so that they capture images of the light emitted by the phantom 102 from different angles. The images from multiple, different positions can then be combined, for example using ImageJ™ software, to produce a three-dimensional image of the light pattern within the phantom 102.

Optionally, the cameras 122 can be positioned generally equidistantly around the track 118, such that an angle 128 between the cameras 122 is about 120 degrees (only one angle 128 is shown for clarity, but the angles between the other cameras 122 may have the same features as described with relation to angle 128). Alternatively, the cameras 122 need not be equally spaced apart from each other. Optionally, at least two of the cameras 122 may be orthogonal to each other, such that angle 128 is about 90 degrees. Alternatively, the angle 128 between any two cameras 122 may be between about 5 degrees and about 360 degrees.

In the illustrated embodiment, the cameras 122 lie on a common, generally horizontal plane (as illustrated) defined by the track 118. Alternatively, or in addition to the cameras 122 on a common plane, one or more additional cameras may be provided in another plane, spaced apart from the plane defined by the track 118. For example, a camera 122a (shown in dashed lines) may optionally be provided above the track 118 to shoot generally downwardly toward the phantom 102. This may give an additional perspective on the phantom 102. The arrangement of the cameras 122 during any given measurement session may be based on a variety of factors, including, for example, the shape of the phantom 102, the configuration and sensitivity of the cameras, the nature of the radiation source 106 and other factors.

In the illustrated embodiment, the scintillating gel is formed such that the phantom 102 is not permanently physically or chemically altered in a material way (i.e. such that it renders the gel unsuitable for further use) by its exposure to the radiation from the radiation source 106. This may allow the phantom 102 to be reused for multiple dosage measurement sessions, and optionally, to be used in combination with different radiation sources 106.

When the phantom 102 is subjected to incoming, ionizing radiation (illustrated as dashed lines 130) it will emit an amount of light (illustrated as wavy lines 132) that is proportional to the dose of radiation received by the phantom 102. The intensity of the light emitted by the phantom 102 may vary at different locations on or within the phantom 102 based on the amount of radiation reaching each portion of the phantom 102.

Light emitted from the phantom 102 can be captured and imaged on the cameras 122. Data from the cameras 122 can be transmitted to any suitable controller or computer, such as controller 134 for processing. The controller 134 may be any suitable apparatus including a computer and a microprocessor, that is operable to analyze and process the individual, two-dimensional images captured by each camera 122, and generate a representative three-dimensional image (for example by running ImageJ™ software). Providing a three-dimensional representation of the light emission pattern may enable a user to determine the overall dosage of radiation received by the phantom 102, as well as its distribution or path within the phantom 102. Determining the distribution of the radiation, as well as the overall dosage, may allow a user to concentrate the radiation exposure on the desired portions of a patient, while optionally trying to limit the dosage received by surrounding tissues.

The controller 134 may be communicably linked to the cameras 122 using any suitable mechanism, including, for example a wire 136 and via wireless transmitters. Providing wireless communication (a transmitter in the camera(s) 122 and a receiver in the controller 134) may reduce the number of wires connected to the cameras, which may help prevent tangling or other problems when the cameras 122 are moved. It may also help prevent the wires 134 from being exposed to radiation or other electromagnetic interference which may affect data transmission quality. Optionally, the cameras 122 may include an onboard power source (e.g. a battery) and need not include any external wires.

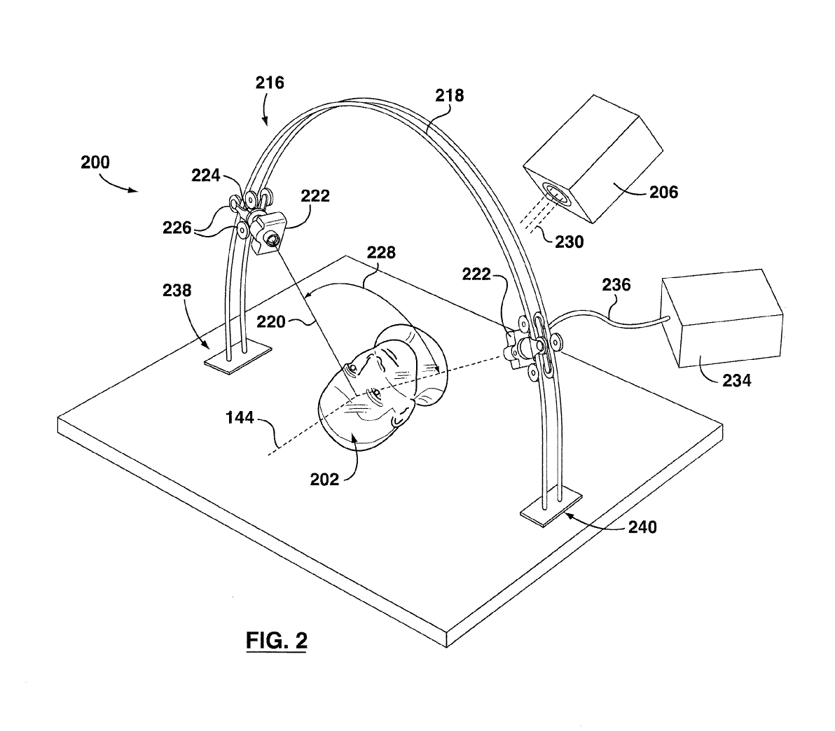

Referring to FIG. 2, another example of an embodiment of a real-time, three-dimensional dosimetry system 200 is illustrated. The real-time, three-dimensional dosimetry system 200 is generally similar to the system 100, and analogous elements are identified using like reference characters indexed by 100. In the illustrated embodiment, the system 200 includes a three-dimensional phantom 202 and an imaging apparatus 204.

In this embodiment, the imaging apparatus 204 includes a track 218 that extends between first and second ends 238 that are coupled to a table supporting the phantom 202. In this configuration, the track 218 is does not extend completely around the phantom 202, and the cameras 222 cannot be positioned below the phantom 202 (as illustrated). Instead, the cameras 222 may be moved to one or more desirable positions or angles relative to the phantom 202, along the length of the track 218. Optionally, the cameras 222 may be positioned so that they are generally orthogonal to each other (e.g. such that angle 238 is about 90 degrees). Alternatively, they can be positioned in another configuration.

If the cameras 222 are configured to be moveable while the measurement is underway (e.g. to capture images from multiple positions with one camera) the cameras 222 may be moved in unison (e.g. both the left or both to the right, as illustrated in FIG. 2). In this configuration, both cameras 222 may be connected to a common drive actuator. Alternatively, the cameras 222 may be moveable independently from each other.

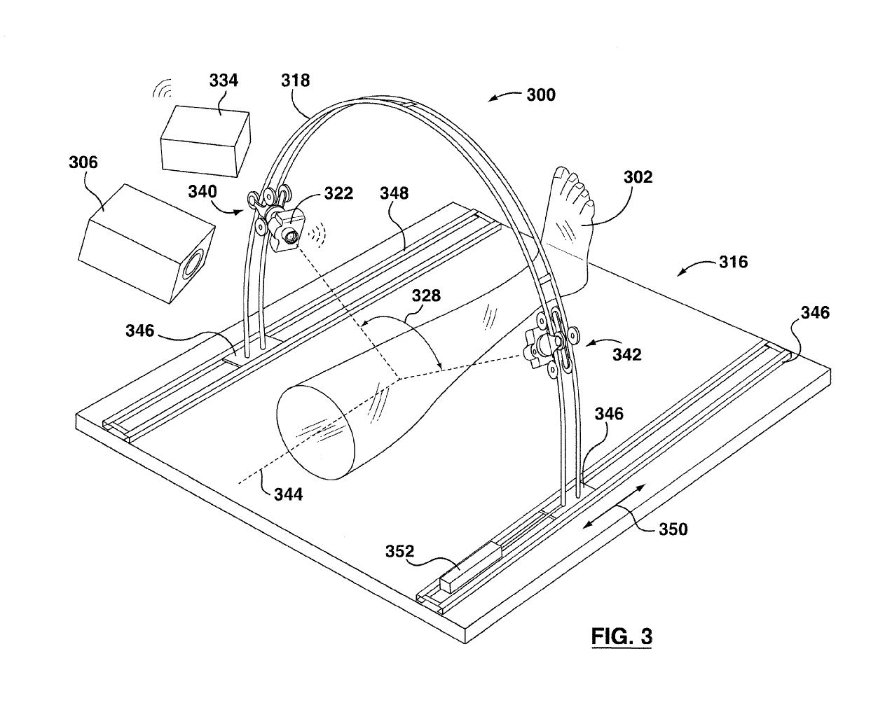

Referring to FIG. 3, another example of an embodiment of a real-time, three-dimensional dosimetry system 300 is illustrated. The real-time, three-dimensional dosimetry system 300 is generally similar to the system 100, and analogous elements are identified using like reference characters indexed by 100.

In the illustrated embodiment, the system 300 includes a single camera 322 mounted on a frame 318. A phantom 302 is positioned on an underlying table to receive radiation from radiation source 306. In this example, the phantom 302 is provided in the form of a replica of a human leg, instead of a head (as shown in FIG. 1). The leg phantom 302 is formed from a suitable scintillating gel material that is generally tissue-equivalent to human leg tissue. Optionally, the properties of the scintillating gel used to make the leg phantom 302 may be different than the properties of the scintillating gel used to make the head phantom 102. For example, if human head tissue and human leg tissue have different properties.

To capture images of the light emitted from irradiated leg phantom 302 from multiple positions, the camera 322 is moveable between a first position 340 and a second position 342 (indicated using dashed lines). The second position 342 may be any suitable position, and may be selected so that angle 328 is about 90 degrees (as defined as the intersection of the axis of the cameras 322 at a phantom axis 344). Optionally, the camera 322 may be moved to more than two different positions relative to the phantom 302. As illustrated, the camera 322 is movingly coupled to the track 318 using a slider 324. The slider 324 may be driven using any suitable actuator, and the actuator (in any configuration) may be controller by the controller 334.

In the illustrated embodiment, instead of using a wire, information from the camera 322 is wirelessly transmitted to the controller 334.

Optionally, the cameras in any of the real-time, three-dimensional imaging dosimetry imaging system may be moveable in more than one direction, and/or about more than one axis. For example, a camera may be both rotatable about a phantom axis and translatable along the phantom axis. This may allow a camera to image different axial portions of the phantom without changing the direction the camera is pointed.

Referring to FIG. 3, in the illustrated embodiment the frame 316 includes a pair of space apart rails 346. The track 328 is coupled to the rails 328 using shoes 348 and is slidable along the rails 346 in the axial direction (as illustrated using arrow 350). The track 318 can be moved using any suitable actuator, including, for example hydraulic cylinder and piston actuator 352. The actuator 352 can be supplied with fluid from any suitable source, and may be controller by controller 334.

The leg phantom 302 may be formed using any suitable method, including, for example, filling a leg shaped mold with scintillating gel material in its liquid state, allowing the gel to solidify and then removing the phantom 302 from the mold.

Optionally, phantoms formed from the scintillating gel material may be configured to have different objects embedded within them. Due at least in part to the gel-like properties of the gel material, objects embedded within phantoms formed from scintillating gel may be generally supported by the gel and may remain in their desired locations (relative to the surrounding phantom) when the phantom is use and/or when the phantom is transported or stored. The objects embedded within the phantoms may be any suitable objects including, for example, objects formed from scintillating gel with different properties than the surrounding phantom material, radiation emitting objects and simulator objects. A simulator object may be any type of object or material that is intended to help make the phantom absorb radiation in a manner that is representative of the human tissue being modeled. Optionally, in some embodiments, the simulator object may also be a support member that can internally support the phantom. This may help the phantom maintain a desired shape and/or configuration when some or all of the external mold or vessel is removed. For example, if the phantom is a human leg, a simulator object may be inserted within the phantom to represent the bones and/or tendons within the leg. Optionally, the simulator object may be formed from a tissue-equivalent material. Alternatively, the simulator object may be actual organic tissue or matter. For example, to simulate a leg, an actual human bone could be embedded within a leg-shaped phantom. This may help replicate the dosage of radiation received by tissues that are located behind bones, etc. relative to the radiation source.

Referring to FIG. 8, an example of embodiment of a phantom 402 is illustrated. The phantom 402, in mold 408, is generally similar to phantom 102, and like features are illustrated using like reference characters indexed by 300. In the illustrated embodiment, a schematic representation of radiation source 456 is illustrated as being embedded within the phantom 402. The radiation source 456 may be any suitable source, including, for example an alpha or beta radiation emitting source. Regions of the phantom 402 receiving radiation from the source 456 will illuminate, and the illumination may be captured using any of the systems described herein.

Providing an ionizing radiation source 456 within the phantom 402 may allow any suitable dosage measurement system (including the embodiments described herein) to measure the radiation doses received by the tissue surrounding the radiation source 456. This configuration does not require an external radiation source or radiation emitting device. Phantom 402 may allow the dosage measurement system to measure the dosage a human patient is likely to receive from an implanted or embedded radiation source.

Referring to FIG. 9, an example of embodiment of a phantom 502 is illustrated. The phantom 502, in mold 508, is generally similar to phantom 102, and like features are illustrated using like reference characters indexed by 400. In the illustrated example, the phantom 502 is a leg-shaped scintillating gel phantom that includes a simulator object in the form of a bone member 558 embedded within the phantom 502.

The bone member 558 may be an actual bone(s), or may be formed from a material having properties that are generally equivalent to human bone (density, radiation absorption, neutron cross-section, etc.). Using a phantom 502 that includes a bone member 558 may allow the phantom 502 to more accurately model the radiation absorbing characteristics of a human leg, as compared to a phantom that does not include a simulator object.

The bone member 558 may be made from any suitable organic or inorganic material.

Referring to FIG. 10, an example of embodiment of a phantom 602 is illustrated. The phantom 602, in mold 608, is generally similar to phantom 102, and like features are illustrated using like reference characters indexed by 500. In this embodiment, the phantom 602 is formed from scintillating gel and is provided in the shape of a human torso.

In the illustrated example, the phantom 602 includes embedded objects 660 that are formed from scintillating gel material that has different characteristics (density, neutron cross-sectional area, etc.) than the gel material used to form the rest of the phantom 602. Optionally, the characteristics of the objects 660 can be selected to mimic the radiation absorption characteristics of soft tissue objects and/or organs.

In the illustrated example, the objects 660 are configured to generally resemble human lungs, and are formed from a scintillating gel material that mimics human lung tissue characteristics. The objects 660 may optionally be denser or less dense than the surrounding scintillating gel matrix. Densified regions (or less dense regions) within the phantom 602 may take any suitable shape or form to mimic any desired organ or other tissues.

Optionally, the objects 660 may also be positioned within the phantom 602 in anatomically accurate positions.

Optionally, a phantom may include multiple different types of embedded objects. For example, a single phantom may include an embedded radiation source, an embedded simulator object, objects formed from scintillating gel with different properties than the rest of the gel forming the phantom, and any combination or sub-combination thereof.

Optionally, a phantom including an internal radiation source may also be subjected to radiation from an external radiation source.

To help evaluate scintillating gel-based three-dimensional, real-time dosimetry systems, an experiment was conducted using a regular off the shelf digital camera and liquid scintillator consisting of linear alkyl benzene (LAB) loaded with a fluor. The experiment was used to help demonstrate that the scintillations produced by a liquid scintillator can be used to record an image with a digital camera apparatus. When the liquid scintillator was irradiated (51.6 R/h) for a duration of 4 minutes, the digital camera apparatus was able to record an image of the scintillator. The total dose received by the scintillator was 3.44 R (0.03 Sv). An issue with the image produced during this experiment was a high quantity of noise present and the small dynamic range. These factors may affect the precision and accuracy of the measurement.

A follow up experiment was then conducted in which an image intensifier was coupled with a digital camera and was used as an example of an imaging apparatus. The image intensifier coupled camera system improved the sensitivity by a factor of about 15.5 times and improved the signal to noise ratio (SNR) by a factor of about 7.3 times. This imaging apparatus was able to detect a dose of 0.274 R (2.74 mSv), which corresponds to an exposure for 20 seconds to a dose rate of 49.3 R/h.

Another experiment was also conducted to measure the dose linearity of the system which is the relationship between the total light output and the total dose given. Ideally this relationship should be linear, which corresponds to a R² value of 1. The R² value measured in the dose linearity experiment was determined to be about 0.9439.

An experiment was conducted to determine if a proposed scintillating gel material also produced based on LAB was suitable for use in a three-dimensional, real-time dosimetry system. The experiment was also conducted to investigate the dose rate dependence and gamma energy dependence of the scintillating gel-based three-dimensional, real-time dosimetry system.

The experiment was conducted using the equipment set out below in Table 1:

TABLE 1

| | |
|---|---|
| Camera | Double sided tape |
| image intensifier | Measuring tape |
| Tripod | Compact Flash memory card |
| | reader |
| Camera remote | Charger and spare battery for |
| | camera |
| Dark cloth | Flashlight |
| Scintillator sample | Timer |
| Clamp for shutter | Batteries for CVD |
| Nanopure water sample | Blank gel sample |

The equipment was setup similar to the previous experiment. The scintillating gel bottle was placed at the front of the testing table (about 16.8 cm from the centre of the table) using double sided tape. The table was then positioned as close as possible to the gamma irradiator (about 56.4 cm from the centre of the table to the gamma irradiator) and the height of the table was adjusted to align the gamma irradiator and the scintillating gel bottle. The camera image intensifier system was mounted on the tripod and positioned (about 60 cm from the bottle) in a manner to prevent direct irradiation of the imaging system. The camera was set to the pre-determined optimal settings and the exposure time was chosen to ensure that the CCD does not over-saturate. The shutter remote was connected to the camera and the dark cloth is placed over the whole setup to prevent external light from entering the system. Once the setup was ready the camera shutter was opened using the shutter remote and the clamp. The scintillating gel was irradiated for the desired irradiation time and was then switched off. The camera shutter was then closed by removing the clamp. This procedure was repeated to acquire images at different settings and exposure times.

The initial part of the experiment was used to determine the irradiation time required to record an image from the scintillations of the scintillating gel. After this initial experiment the goal was to conduct two experiments to test the dose rate dependence of the scintillating gel and the gamma energy dependence of the gel and liquid scintillators.

The dose rate dependence is a measure of the dependence of the total light output on the dose rate for the same dose. For a given total dose, the total light output should preferably be independent of the dose rate. In this experiment, the dose rate dependence was measured by taking measurements at different dose rates. The dose rate was varied by changing the distance between the scintillator and the gamma irradiator. The distance between the gamma irradiator and the scintillating gel was changed by moving the table farther back.

The gamma energy dependence determines the dependence of the total light output on the energy of the gamma ray for a given total dose. This is measured by using two different sources to change the energy of the gamma rays. Preferably for a given dose, the total light output should be independent of the energy of the gamma rays. In this experiment the irradiation time (amount of time LAB is irradiated) was appropriately calibrated for each measurement to help ensure the dose deposited in the scintillator gel material was the same in all the trials. The exposure time (amount of time camera shutter is open) was also kept substantially the same for all of the trials.

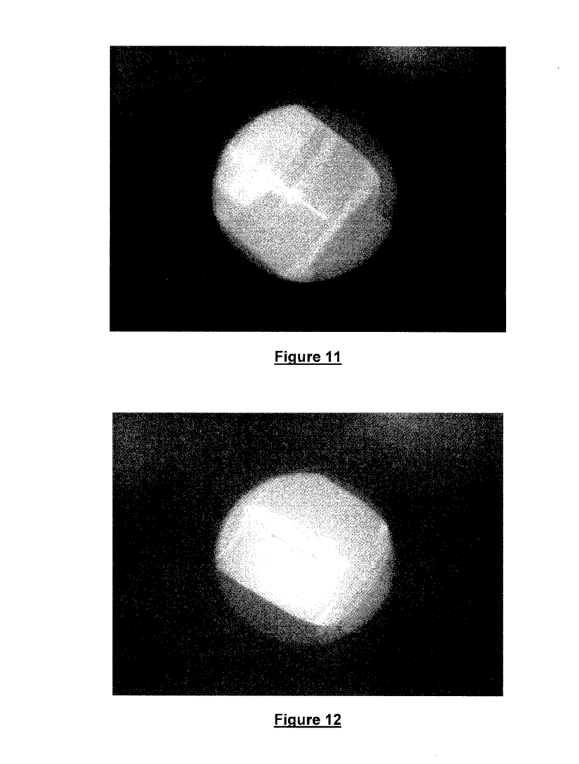

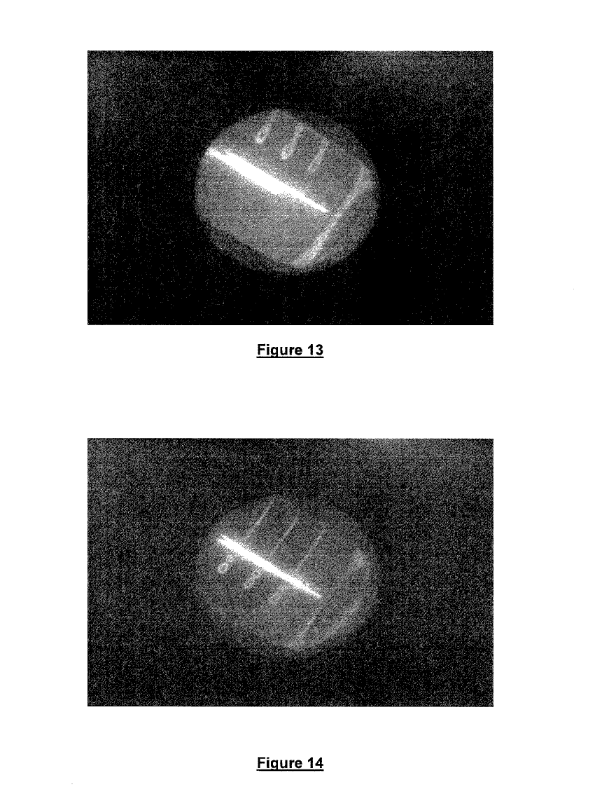

All the images referred to below were taken at an ISO setting of 200 and the dose rate and irradiation times were varied for the respective tests. The images of the scintillating gel material, a liquid scintillator, a blank (i.e. non-scintillating gel), and a nanopure water sample are shown in FIGS. 11, 12, 13, and 14 respectively.

As it can be seen in the images, there is a bright spot at the top right corner of the images, there is a circular area in the image which can only be used to take an image of the subject, and the image is grainy. The bright spot at the top right corner is believe to be due to a defect in the CCD camera used for the experiment, which causes the presence of a bright spot during long exposure times. This bright spot was observed in the previous experiments using this equipment and other trials as well.

Different tests and trials were conducted in order to measure the gamma ray energy dependence, the difference between the liquid scintillator and the gel, and to determine whether the blank gel has any light output. The data from these trials is summarized in Table 2 below.

TABLE 2
Summary of Results of Experiment Trials

| | | | Dose | | Total | | | | |
|---|---|---|---|---|---|---|---|---|---|
| | | Distance | Rate | Irradiation | Dose | Average | Standard | Background | |
| Medium | Source | (cm) | (R/h) | Time (s) | (R) | Grayscale | Deviation | Subtracted | Error |
| Scintillating | 30 Ci | 39.6 | 49.1 | 60.0 | 0.82 | 219 | 9 | 97 | 19 |
| gel | Cs-137 | | | | | | | | |
| Scintillating | 10 Ci | 39.6 | 36.5 | 80.7 | 0.82 | 219 | 8 | 97 | 18 |
| gel | Co-60 | | | | | | | | |
| LAB-LS | 30 Ci | 39.6 | 49.1 | 60.0 | 0.82 | 234 | 3 | 112 | 17 |
| | Cs-137 | | | | | | | | |
| LAB-LS | 10 Ci | 39.6 | 36.5 | 80.7 | 0.82 | 232 | 3 | 111 | 17 |
| | Co-60 | | | | | | | | |
| Blank Gel | 30 Ci | 39.6 | 49.1 | 60.0 | 0.82 | 151 | 14 | 29 | 21 |
| | Cs-137 | | | | | | | | |
| Nanopure | 30 Ci | 39.6 | 49.1 | 60.0 | 0.82 | 122 | 16 | 0 | 23 |
| Water | Cs-137 | | | | | | | | |

A program named ImageJ™ (a public-domain Java-based image processing program develop by the National Institutes of Health) was used to analyze the images and measure the grayscale values. The average grayscale values and the standard deviation were measured using the ImageJ software. A 200 by 200 pixel area (40,000 pixels) covered by the bottle was selected and the average grayscale values and standard deviation were determined using the ImageJ software. The same region of the bottle was selected in the other images to calculate the average grayscale values and the standard deviation. The background subtracted grayscale values were calculated by subtracting the average signal for the water sample from the average signal for the other sources. Equation 1 below demonstrates how the background subtracted values (BSᵢ) are calculated using the average grayscale values (AGᵢ) and the average grayscale value for the water sample (AG_{W}). Equation 2 demonstrates how the error (δᵢ) is calculated using the standard deviation of the average grayscale values (σᵢ) and the standard deviation of the average grayscale value for the water sample (σ_{W}). Here ‘i’ represents the sample in question for which the calculation is being performed.

BSᵢ=AGᵢ−AG_{W} (1)

δᵢ=\sqrt{σᵢ²+σ_{W}²} (2)

### Gamma Ray Energy Dependence

The gamma ray energy dependence was measured for both the LAB liquid scintillator and the scintillating gel. This dependence was measured by changing the radioactive source and radiating the sample with the same total dose. The two sources used for this experiment were Cs-137 and Co-60. Cs-137 emits a gamma ray with an energy of 0.662 MeV while Co-60 emits two gamma rays with energies of 1.17 MeV and 1.33 MeV. Table 2 shows that both the scintillating gel and the liquid scintillator have approximately the same average grayscale values for the two different sources. Using this the inventors concluded that for a given total dose the light output of the scintillating gel and the liquid scintillator is independent of the energy of the gamma rays.

### Comparison of Scintillating Gel and Liquid Scintillator Samples

One of the concerns of using a scintillating gel instead of a liquid scintillator was that the scintillating gel may have a significantly lower light output than the liquid scintillator. In order to determine the effectiveness of the scintillating gel, the light output of the scintillating gel was compared with the light output of the liquid scintillator for the same total dose. The equation below calculates the difference in the effectiveness of the gel. In Equation 3, below, the percent difference (PD) is calculated using the background subtracted value of the scintillating gel sample (S_{G}) and the background subtracted value of the liquid scintillator sample (S_{S})

$$PD = \frac{\vert {S}_{G} - {S}_{S} \vert}{{S}_{S}} \times 100 \% \\ PD = \frac{\vert 97 - 112 \vert}{112} \times 100 \% = 13.4 \% \qquad ( 3 )$$

The calculation above demonstrates that the difference in the light output of the scintillating gel and the liquid scintillator is 13.4% and the effectiveness of the scintillating gel is 66.6% of the liquid scintillator.

### Comparison of Blank Gel and Nanopure Water Samples

The nanopure water and blank gel samples were used to serve as controls and references. It was expected that the water will not scintillate but the same is not true for the blank gel used because it was fabricated using LAB which is a scintillating material. The UV output of the blank gel, caused by the LAB was tested by irradiating both the water and blank gel samples for the same total dose. The average grayscale value for the blank gel was measured as 151 and the average grayscale value for the water sample was measured as 122. This reaffirms the fact that the blank gel contains components that cause it scintillate and output light. Equation 4, below, is used to calculate the percent difference between the output of the water and blank gel samples. The average grayscale value of the blank gel is represented by S_{B} and the average grayscale value of the nanopure water is represented by S_{W}.

$$PD = \frac{\vert {S}_{H} - {S}_{W} \vert}{{S}_{W}} \times 100 \% \\ PD = \frac{\vert 151 - 122 \vert}{122} \times 100 \% = 23.8 \% \qquad ( 4 )$$

The calculation above demonstrates that the UV light emitted by the blank gel generates a 23.8% higher signal output than the nanopure water sample. This is to be expected since the blank gel was made using LAB which is a scintillating material.

### Dose Rate Dependence

In the dose rate dependence experiment the dependence of the light output, of the scintillating gel, on the dose rate is measured for a given dose. The dose rate is varied by changing the distance between the gamma irradiator and the sample and the total dose is kept constant by changing the exposure time. Table 3 below summarizes the results of this experiment. The subtracted background and error values were calculated as previously shown in Equations 1 and 2.

TABLE 3
Summary of Results for Dose Rate Dependence Experiment Trials

| | | | Dose | | Total | | | | |
|---|---|---|---|---|---|---|---|---|---|
| | | Distance | Rate | Irradiation | Dose | Average | Standard | Background | |
| Source | Medium | (cm) | (R/h) | Time (s) | (R) | Grayscale | Deviation | Subtracted | Error |
| 30 Ci | Scintillating | 39.6 | 49.1 | 58.1 | 0.79 | 209 | 9 | 87 | 19 |
| Cs-137 | gel | | | | | | | | |
| 30 Ci | Scintillating | 44.6 | 38.7 | 73.7 | 0.79 | 205 | 13 | 83 | 21 |
| Cs-137 | gel | | | | | | | | |
| 30 Ci | Scintillating | 49.6 | 31.3 | 91.1 | 0.79 | 204 | 7 | 82 | 18 |
| Cs-137 | gel | | | | | | | | |
| 30 Ci | Scintillating | 54.6 | 25.8 | 110.8 | 0.79 | 206 | 6 | 84 | 17 |
| Cs-137 | gel | | | | | | | | |
| 30 Ci | Scintillating | 59.6 | 21.7 | 132.1 | 0.79 | 207 | 7 | 85 | 18 |
| Cs-137 | gel | | | | | | | | |
| 30 Ci | Scintillating | 64.6 | 18.4 | 154.8 | 0.79 | 208 | 7 | 86 | 18 |
| Cs-137 | gel | | | | | | | | |
| 30 Ci | Scintillating | 69.6 | 15.9 | 180.0 | 0.79 | 207 | 7 | 85 | 18 |
| Cs-137 | gel | | | | | | | | |

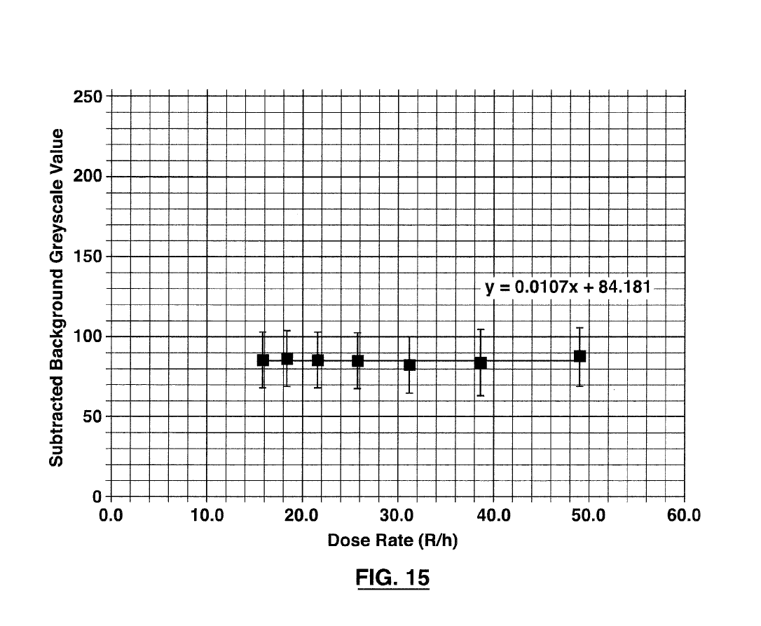

The background subtracted grayscale values were plotted against the dose rate and the graph is shown in FIG. 15. FIG. 15 is a plot of the subtracted background grayscale values of the scintillating gel versus the dose rate. The line of best fit appears to be horizontal and it fits within the error of the values. The slope for the line is 0.0107 which is close to the ideal value of zero. A slope of zero suggests that the two parameters are not dependent on one another. The correlation coefficient was measured to be 0.078 which is close to the ideal value of zero (for no correlation). Therefore the light output is believed to be independent of the dose rate for a given total dose.

This feature of the scintillating gel meets one of the preferred qualities or characteristics for a real-time 3D dosimetry system, which is that the light output of the scintillator is substantially independent of the dose rate for a given total dose.

Based on the results of this experiment, the inventors believe that a scintillating gel material can be used as a tissue equivalent medium for a real-time, three-dimensional dosimetry system.

The inventors believe that some advantages of a scintillating gel over a liquid scintillator may be that it can be used to produce a solidified phantom, it can hold a radiation source or other object in place (i.e. embedded or suspended within the gel material itself without the need for a separate support member), and it may be used to produce a tissue equivalent phantom.

In the present experiment the effectiveness of the scintillating gel was determined to be 86.6% relative to the effectiveness of the liquid scintillator. The blank gel contained some scintillating material since it produced a slightly higher light output (23.8%) than the nanopure water sample. This was expected by the inventors because the blank gel was made using LAB which would scintillate and emit light in the UV region. It was determined that both the scintillating gel and liquid scintillator are independent of the energy of the gamma rays for a given total dose. The dose rate dependence, for a given total dose, of the scintillating gel was determined by measuring the correlation coefficient of the data. The correlation coefficient was measured as 0.078 which is very close to the ideal value of zero (horizontal line). This suggests that the scintillating gel is independent of the dose rate for a given dose and therefore may be suitable for use in a real-time, three-dimensional dosimetry system.

What has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A system for determining a radiation dose in real time, the system comprising:
a) at least one three-dimensional target object to be exposed to ionizing radiation, the at least one target object comprising a scintillating gel material, the scintillating gel material operable to emit light, or other electromagnetic radiation, when exposed to the ionizing radiation;
b) an imaging system configured to capture at least a first image of the target object from a first position, and a second image of the target object from a second position relative to the target object; and
c) a controller connected to the imaging system and configured to the process the first and second images to provide a three-dimensional dose distribution in real-time.

2. The system of claim 1, wherein the scintillating gel material is tissue equivalent.

3. (canceled)

4. The system of claim 1, wherein a portion of the scintillating gel material is contained within a mold.

5. The system of claim 1, including a support at least partially supporting the scintillating gel and wherein the support simulates human bone or comprises at least one human bone.

6. (canceled)

7. (canceled)

8. The system of any one of claims 1, wherein the scintillating gel material comprises about 10% by weight Hydrogen, about 67% by weight Carbon and about 22% by weight Oxygen and has a density of about 1 g/cm³.

9. The system of claim 1, wherein the target object is reusable and is not chemically or physically altered by the ionizing radiation.

10. The system of claim 1, wherein the imaging system includes at least one imaging device that is moveable relative to the target object between the first and second positions.

11. (canceled)

12. (canceled)

13. The system of claim 1, wherein the imaging system comprises a first imaging device in a first position and a second imaging device in a second position and wherein at least one or the first and second imaging devices is movable between the first and second positions relative to the target object and the other of the first and second imaging devices is movable to a third position relative to the target object to capture a third image of the light emitted from the scintillating gel.

14. (canceled)

15. The system of claim 1, wherein the density of the scintillating gel varies within the target object.

16. The system of claim 1, wherein the target object includes at least one densified region that is configured to simulate human organ tissue.

17. (canceled)

18. (canceled)

19. The system of claim 1, further comprising at least one simulator object embedded within the scintillating gel.

20. The system of claim 1, wherein a source of ionizing radiation is embedded within the scintillating gel.

21. The system of claim 1, wherein the target object is of integral, one-piece construction and is formed entirely from the scintillating gel material.

22. (canceled)

23. A method of determining a radiation dose in real time, the method comprising:
d) providing a target object formed from a scintillating gel material;
e) irradiating the target object with a source of ionizing radiation and producing light with the scintillating gel in response;
f) capturing a first image of the light produced by the scintillating gel from a first position relative to the target object;
g) capturing a second image of the light produced by the scintillating gel from a second position relative to the target object, the second position being spaced apart from the first position; and
h) generating a three-dimensional dose distribution of the target object based on at least the first and second images.

24. The method of claim 23, wherein the three-dimensional dose distribution is generated in real-time.

25. The method of claim 23, wherein the first image is captured using a first imaging device disposed in the first position.

26. The method of claim 25, wherein the second image is captured using the first imaging device after moving the first imaging device from the first position to the second position.

27. The method of claim 25, wherein the second image is captured using a second imaging device disposed in the second position.

28. The method of claim 22, further comprising embedding at least one of the source of ionizing radiation and a non-gel object within the gel target object.

29. (canceled)

30. A method of manufacturing a three-dimensional phantom, the method comprising:
i) pouring a scintillating material in fluid state into a three-dimensional phantom mold; and
j) setting the scintillating material into a gel state to provide a three-dimensional gel phantom.

31-35. (canceled)
